(19) United States
(12) Patent Application Publication
(10) Pub. No.: US 2006/0277874 A1
(43) Pub. Date: Dec. 14, 2006

(54) Vacuum cleaner

(75) Inventor: Myung Sig Yoo, Changwon-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/409,951

(22) Filed: Apr. 25, 2006

(30) Foreign Application Priority Data
Jun. 10, 2005 (KR) P2005-0049799

(51) Int. Cl. B01D 47/00

(52) U.S. Cl. 55/429

(57) ABSTRACT

A vacuum cleaner is disclosed, by which a dust collecting device is facilitated to use. The present invention includes a cleaner body, a cyclone chamber having a primary cyclone separating particles from an introduced air and at least one secondary cyclone provided outside the primary cyclone to re-separate particles contained in the air discharged from the primary cyclone, a dust collecting container detachably assembled to the cleaner body, the dust collecting container including a primary dust storing part storing dust separated by the primary cyclone and a secondary dust storing part storing dust separated by the at least one secondary cyclone, and a fixing means for assembling/dissembling the dust collecting container and the cyclone chamber.

This application claims the benefit of the Korean Patent Application No. P2005-49799, filed on Jun. 10, 2005, which is hereby incorporated by reference as if fully set forth herein.

### BACKGROUND OF THE INVENTION

1. Field of the Invention

The present invention relates to a vacuum cleaner. Although the present invention is suitable for a wide scope of applications, it is particularly suitable for separating particles from an introduced air using a cyclone principle.

2. Discussion of the Related Art

Generally, a vacuum cleaner according to a related art consists of an intake nozzle sucking particles such as dust and the like from a floor, a cleaner body having a dust-collecting container to collect dust by separating the particles, and a connecting tube guiding the particles sucked through the intake nozzle to the cleaner body.

A cyclone dust collector is a device that collects particles such as dust and the like contained in air using the cyclone principle. The cyclone dust collector is applicable to various fields, and more particularly, to a vacuum cleaner as a home appliance.

An upright type vacuum cleaner according to a related art is explained with reference to FIGS. 1 to 2B as follows.

Referring to FIGS. 1 to 2B, an upright type vacuum cleaner is generally used for a large-scale area such as a living room and the like, and more particularly, a place covered with a carpet.

The vacuum cleaner consists of a cleaner body 10 standing upright, an intake nozzle 20 assembled to a lower part of the cleaner body 10, and a connecting tube 40 connecting the cleaner body 10 and the intake nozzle 20 together.

The intake nozzle moves around a floor to suck air containing various particles such as dust and the like. The cleaner body 10 plays a role in separating the particles from the sucked air. In particular, a dust collecting container 33 is detachably assembled to the cleaner body 10 to separate particles from the sucked air.

An air intake device (not shown in the drawing) is provided to the cleaner body 10 to generate an air intake force. And, a cleaner handle 30 is provided to one side of the cleaner body 10 to carry the cleaner body 10.

Meanwhile, once particles such as dust are piled up within the dust collecting container 33 of the above-configured vacuum cleaner, a user needs to empty the dust collecting container 33 by removing the piled particles from the dust collecting container 33.

For this, the dust collecting container 33 and the cleaner body 10 are assembled together by a hook locking system in the related art.

In particular, a dust collecting handle 33a is built in one body of an outer circumference of the dust collecting container 33 and a hook 33b is provided to a lower part of the dust collecting container handle 33a.

And, a hanging recess 11a is formed at the cleaner body 10 to correspond to the hook 33b.

Moreover, a coupling hole 33c having a prescribed shape is formed at an upper part of the dust collecting container handle 33a. And, a hanging sill 11b is formed at the cleaner body 10 to correspond to the coupling hole 33c.

A process of attaching/detaching the dust collecting container to/from the cleaner body is explained with reference to FIG. 2A and FIG. 2B as follows.

First of all, if a user attempts to detach the dust collecting container 33 from the cleaner body 10, the hook 33b provided to the lower end of the dust collecting container handle 33a is shifted upward. If so, the hook 33b escapes from the hanging recess 11a provided to the cleaner body 10 to release a locking of the lower part of the dust collecting container 33.

Subsequently, the dust collecting container 33 having the unlocked lower part is lifted upward to detach the coupling hole 33 from the hanging sill 11b provided to the cleaner body 10.

Thus, by releasing the lockings of the upper and lower parts of the dust collecting container, respectively, the cleaner body 10 and the dust collecting container 33 can be separated from each other.

Meanwhile, a process for assembling the dust collecting container 33 and the cleaner body 100 together can be achieved in a reverse manner of dissembling the dust collecting container 33 and the cleaner body 100 from each other, which is skipped in the following description.

However, the related art vacuum cleaner has the following problems.

First of all, the dust collecting container and the cleaner body are assembled/dissembled by the hook locking system. Namely, a user has to tilt the dust collecting container to separate the dust collecting container from the cleaner body. So, in separating the dust collecting container from the cleaner body while the dust collecting container is tilted, the particles are discharged from the dust collecting container to re-contaminate the environment around the cleaner body.

Secondly, if the dust collecting container having collected a small quantity of particles therein is emptied not to discharge the particles from the dust collecting container, a substantial dust collecting capacity of the dust collecting container is reduced. And, the dust collecting container needs to be frequently emptied.

Thirdly, in the detaching process of the dust collecting container, the upper locking of the dust collecting container is released after the lower locking of the dust collecting container has been released. Hence, it is inconvenient for a user to perform a corresponding task.

### SUMMARY OF THE INVENTION

Accordingly, the present invention is directed to a vacuum cleaner that substantially obviates one or more problems due to limitations and disadvantages of the related art.

An object of the present invention is to provide a vacuum cleaner, by which a dust collecting device is facilitated to use.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a vacuum cleaner according to the present invention includes a cleaner body, a cyclone chamber having a primary cyclone separating particles from an introduced air and at least one secondary cyclone provided outside the primary cyclone to re-separate particles contained in the air discharged from the primary cyclone, a dust collecting container detachably assembled to the cleaner body, the dust collecting container including a primary dust storing part storing dust separated by the primary cyclone and a secondary dust storing part storing dust separated by the at least one secondary cyclone, and a fixing means for assembling/dissembling the dust collecting container and the cyclone chamber.

Preferably, the vacuum cleaner further includes a main filter assembly having a main filter filtering off the particles from the air discharged from the at least one secondary cyclone and a filter support member supporting the main filter.

More preferably, the main filter assembly is detachably provided to an upper part of the at least one secondary cyclone.

Preferably, the fixing means includes a lifting member provided to the cleaner body to be lifted in a vertical direction and a manipulating member manipulating a movement of the lifting member.

More preferably, the lifting member is lifted by a rotational manipulation of ht e manipulating lever.

More preferably, the lifting member is locked to the cleaner body by a screw to be rotatably lifted by the rotational manipulation of the manipulating lever.

More preferably, the dust collecting container is rotated together with the manipulating lever to be lifted by the lifting member.

Preferably, the manipulating lever includes a guide member coupled with an upper side of the lifting member, a guide recess corresponding to the guide member of the manipulating lever is formed on a bottom of the dust collecting container, and the guide member and the guide recess engage with each other in loading the dust collecting container in the cleaner body.

More preferably, a male screw and a female screw are provided to the dust collecting container and the cyclone chamber, respectively, and vice versa and the dust collecting container and the cyclone chamber are screw-locked together if the dust collecting container is rotated by the manipulating lever.

More preferably, the lifting member is lifted by a relative movement to the manipulating lever.

More preferably, the lifting member is lifted by a rotational manipulation of the manipulating lever.

More preferably, the fixing means further includes a ball provided between the lifting member and the manipulating lever to make a rolling movement between the lifting member and the manipulating lever by a rotation of the manipulating lever.

More preferably, the manipulating lever is provided under the lifting member and a groove corresponding to a trajectory of the ball is formed on a lower surface of the lifting member.

More preferably, the lower surface of the lifting member has a tilted shape.

More preferably, the lifting member is lifted by a straight movement of the manipulating lever.

More preferably, the lifting member is lifted in the vertical direction by a front-to-rear movement of the manipulating lever.

More preferably, the fixing means further includes a ball provided between the lifting member and the manipulating lever to make a rolling movement between the lifting member and the manipulating lever by the straight movement of the manipulating lever.

More preferably, the manipulating lever is provided under the lifting member and a groove corresponding to a trajectory of the ball is formed in a front-to-rear direction on a lower surface of the lifting member.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective diagram of a vacuum cleaner according to a related art;

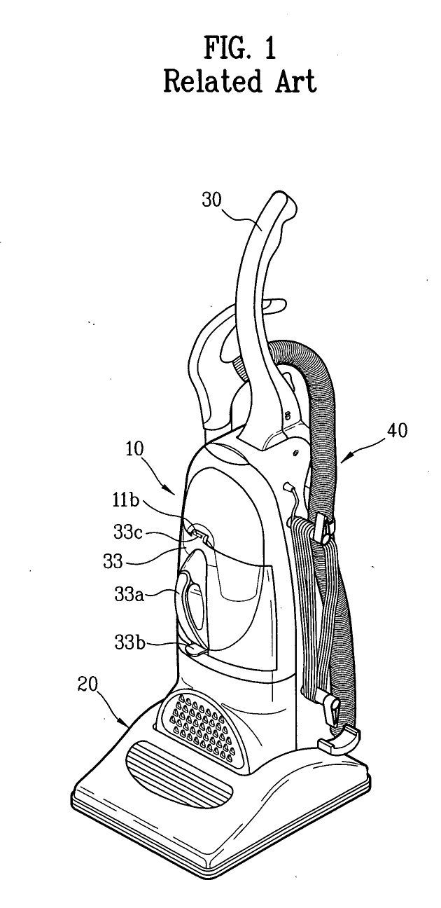

FIG. 2A is a cross-sectional diagram of a dust collecting container shown in FIG. 1, in which a state that the dust collecting container is being separated is shown;

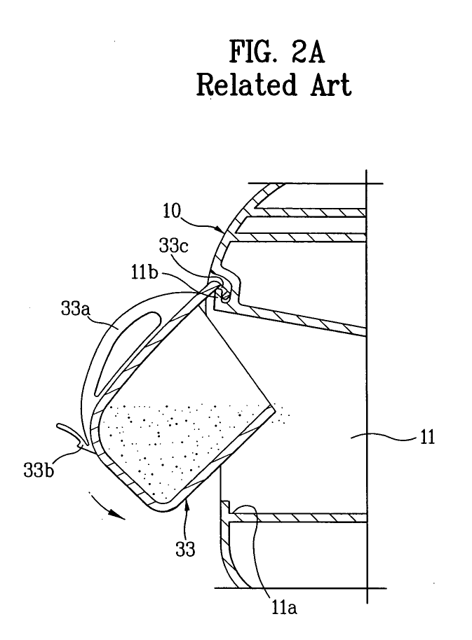

FIG. 2A is a cross-sectional diagram of a dust collecting container shown in FIG. 1, in which a state that the dust collecting container is assembled is shown;

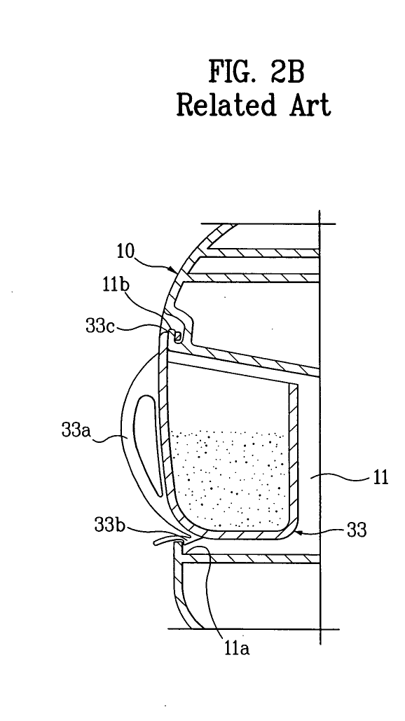

FIG. 3 is a perspective diagram of a vacuum cleaner according to one embodiment of the present invention;

FIG. 4 is a cross-sectional diagram of a vacuum cleaner in FIG. 3 according to one embodiment of the present invention;

FIG. 5 is an exploded perspective diagram of a dust collecting device in FIG. 3 according to one embodiment of the present invention;

FIG. 6 is a perspective diagram of an upper part of a dust collecting device according to the present invention;

FIG. 7 is a perspective diagram of a container separating device according to one embodiment of the present invention;

FIG. 8 is a perspective diagram of a container separating device according to another embodiment of the present invention; and

FIG. 9 is a perspective diagram of a container separating device according to a further embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

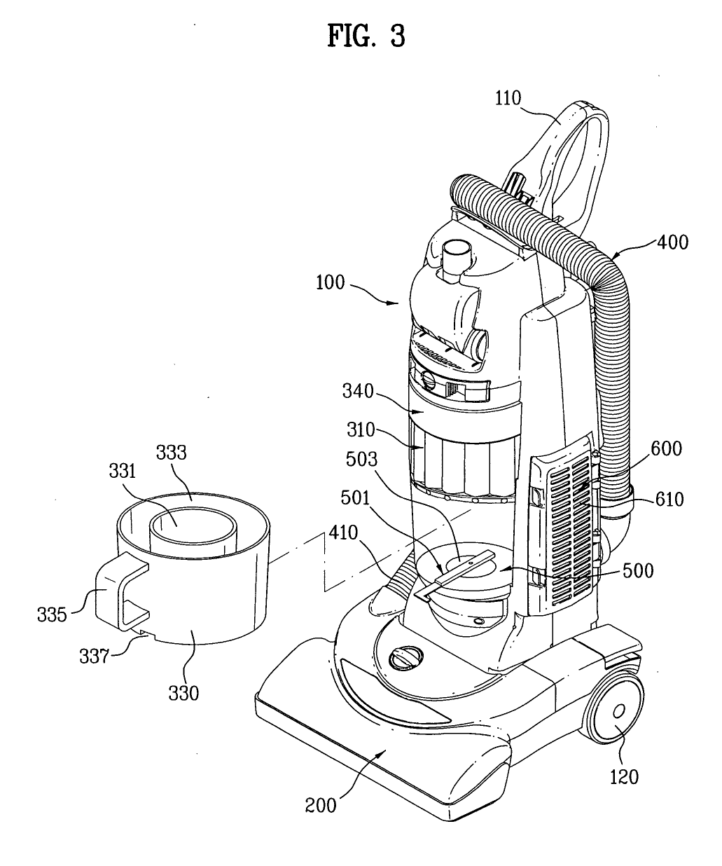

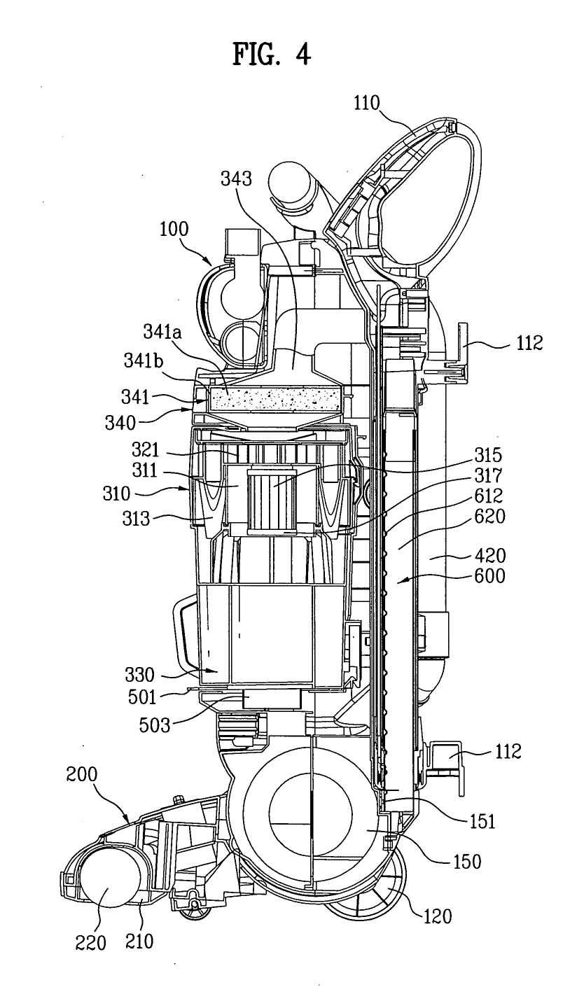

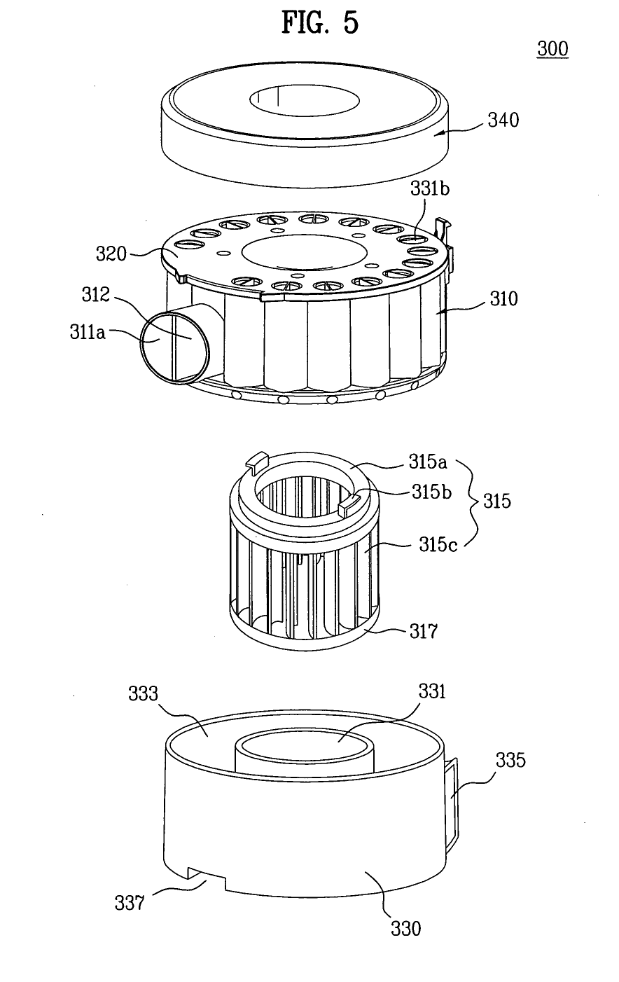

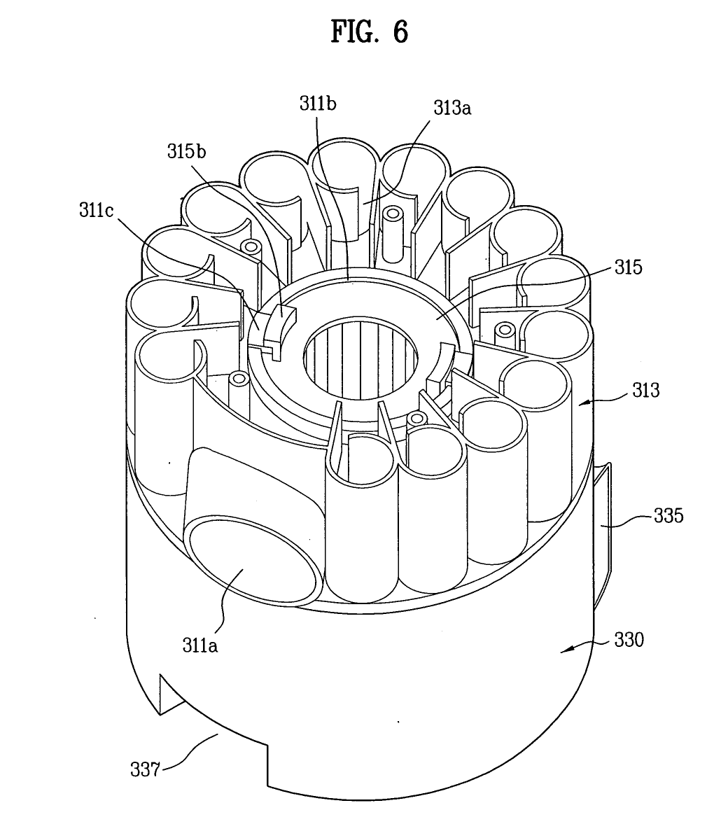

FIG. 3 is a perspective diagram of a vacuum cleaner according to one embodiment of the present invention, FIG. 4 is a cross-sectional diagram of a vacuum cleaner in FIG. 3 according to one embodiment of the present invention, FIG. 5 is an exploded perspective diagram of a dust collecting device in FIG. 3 according to one embodiment of the present invention, and FIG. 6 is a perspective diagram of an upper part of a dust collecting device according to the present invention.

Referring to FIGS. 3 to 6, a vacuum cleaner according to one embodiment of the present invention includes an intake nozzle 200 sucking air containing particles such as dust and the like by moving along a surface of a floor to be cleaned, a cleaner body 100 communicating with the intake nozzle 200, and a connecting tube 400 connecting the intake nozzle 200 and the cleaner body 100 together to guide the air sucked by the intake nozzle 200 to the cleaner body 100.

A plurality of wheels 120 are rotatably provided to one side of the intake nozzle 200 to enable the intake nozzle 200 to move on the floor surface smoothly. A nozzle intake port 210 having a prescribed size is formed on a bottom of the intake nozzle 200. And, an agitator 220 is provided to the nozzle intake port 210 to sweep up particles.

Rotational shafts (not shown in the drawings) are projected from both ends of the agitator 220, respectively, and recesses (not shown in the drawings) are provided to both sidewalls of the nozzle intake port 210 to have the rotational shafts fitted therein, respectively. In particular, a plurality of blades (not shown in the drawings) are preferably provided to an outer circumference of the agitator 220 in a spiral direction.

A plurality of the blades (not shown in the drawings) are provided to be evenly spaced apart from each other. And, a plurality of the blades play a role in detaching particles stacked on or attached to the floor to sweep up to the nozzle intake port 210 while the agitator 220 is rotating optionally, a brush (not shown in the drawings) can be further provided between a plurality of the blades (not shown in the drawing) in the spiral direction.

In order to rotate the agitator 220, an agitator motor (not shown in the drawings) and a belt (not shown in the drawings) transferring a power of the agitator motor (not shown in the drawings) to the agitator 220 are provided to one side of the intake nozzle 200.

So, once a rotational force of the agitator motor is transferred to the agitator 220 via the belt, the agitator 220 is rotated to sweep up particles on the floor to the nozzle intake port 210. Alternatively, the agitator 220 can be driven by an air intake device 150 and a power transmission device provided to one of the cleaner body 100 and the intake nozzle 200.

The cleaner body 100 includes a body inlet (not shown in the drawings) communicating with the intake nozzle to introduce air into an inside of the cleaner body 100 and a body outlet 610 provided to one lateral side of the cleaner body 100 to discharge the air to an outside of the cleaner body 100.

An electronic/electric part (not shown in the drawings) controlling the vacuum cleaner and an air intake device 150 sucking air into the inside of the cleaner body 100 to force the sucked air to flow.

Alternatively, the air intake device 150 can be provided to the intake nozzle 200. In particular, the air intake device 150 includes an air inlet (not shown in the drawings) provided under the dust collecting device to communicate with the dust collecting device and an air outlet 151 communicating with an external atmosphere.

The connecting tube 400 is provided to the cleaner body 100 to guide the air sucked by the intake nozzle 200 to the cleaner body 100 and to guide the air passing through the cleaner body 100 to the external atmosphere.

The connecting tube 400 includes a first connecting tube 410 connecting the nozzle intake port 210 and the dust collecting device 300 together, a second connecting tube 420 connecting the dust collecting device 300 and the air intake (not shown in the drawings) provided to the air intake device, and a third connecting tube (not shown in the drawings) connecting the air outlet 151 provided to the air intake device and the external atmosphere together.

And, an exhaust chamber 600, via which the air passing through the air intake device 150 is discharged, is provided to a lateral side of the cleaner body 100. An exhaust filter 620 is accommodated within the exhaust chamber 600 to re-filter off particles contained in the air that is not discharged outside yet.

Preferably, a HEPA (high efficiency particulate air) filter is used as the exhaust filter to filter of microscopic dust having microscopic particles.

The exhaust filter 620 is installed at a filter support member 612. And, the filter support member 612 is detachably assembled within the exhaust chamber 600 to facilitate an exchange of the exhaust filter 620.

A connecting code support member 112 is provided to a rear side of the cleaner body 100. The connecting code support member 112 plays a role in winding to store a connecting code for supplying a power to the cleaner body 10. Alternatively, the connecting code support member 112 can be provided to a lateral side of the cleaner body 100.

A cleaner handle 110 is provided to an upper end of the cleaner body 100 to handle the cleaner body 100. The dust collecting device 300 is detachably assembled to a front part of the cleaner body 100. And, the dust collecting device 300 plays a role in collecting dust in a manner of separating particles from the air sucked via the intake nozzle 200 from outside.

The dust collecting device 300 includes an approximately cylindrical dust collecting container 330 and a cyclone chamber 310 detachably assembled to the dust collecting container 330.

The cyclone chamber 310 includes a primary cyclone 311 separating particles from the air introduced inside and a secondary cyclone 313 provided outside the primary cyclone 311 to re-separate particles from the air having passed through the primary cyclone 311.

The primary cyclone 311 includes a first inlet 311a communicating with the body inlet and a first outlet 311b communicating with the secondary cyclone 313.

In particular, the primary cyclone 311 has a substantially cylindrical shape of which lower end is open and the same central axis of the dust collecting device 300 to be installed within the dust collecting device.

The first inlet 311a is provided to an upper lateral side of the primary cyclone 311 and the first outlet 311b is provided to a ceiling center of the primary cyclone 311.

The first inlet 311a guides a polluted air introduced from outside in a tangential direction of the primary cyclone 311. In particular, a guide rib 312 is provided to one side of the first inlet 311a to guide the air introduced into the first inlet 311a to make a spiral flow along an inner wall of the primary cyclone 311.

Meanwhile, at least one or more secondary cyclones 313 are provided to an outer circumference of the primary cyclone 311 to re-separate particles from the air discharged from the primary cyclone 311.

In the present embodiment, a plurality of the secondary cyclones 313 are arranged on a circumference of the primary cyclone 311.

In this case, a plurality of the secondary cyclones 313 are arranged on a circumference of an upper part of the primary cyclone to be built in one body of an outer wall of the dust collecting device 300.

Each of the secondary cyclones 313 has a conic portion of which diameter decreases downward and a particle discharge hole is formed at a lower end of the conic part to discharge such particles as dust and the like to the dust collecting container.

A portion of a lateral side of each of the secondary cyclones 313 projected upward is vertically cut to form a second inlet 313a communicating with the first outlet 311b.

The air discharged from the first outlet 311b is introduced into the secondary cyclones 313 via the second inlet 313a. And, the air introduced via the second inlet 313a is lead in a tangential direction of an inner wall of the corresponding secondary cyclone 313 to make a spiral flow along the inner wall of the corresponding secondary cyclone 313.

In this case, the adjacent secondary cyclones 313 are built in one body to contact with each other so that air can be prevented from leaking through a gap between the corresponding secondary cyclones 313.

In addition to the above configuration, the cyclone chamber 310 is installed vertically within the primary cyclone 311 and further includes a blade filter 315 that filters an air within the primary cyclone 311.

The guide rib 312 plays a role in preventing the air introduced into the first inlet 311a from being directly introduced into the blade filter 315.

In this case, the blade filter 315 is provided to a center of the primary cyclone 311 in an axial direction and has a shape of which upper and lower ends are open and closed, respectively.

The blade filter 315 includes a plurality of main blades 315c arranged at a prescribed angle and a support member 315a supporting a plurality of the main blades 315c.

Each of the main blades 315c has a wing shape. Preferably, a virtual extension line of each of the main blades 315c forms an appropriate acute angle with an air flow direction within the primary cyclone 311.

If an angle between the air flow direction and the virtual extension line of the blade is too small, a flow resistance increases. If the angle between the air flow direction and the virtual extension line of the blade is too large, particles contained in the air can easily escape from the blade filter 315.

And, each of the main blades 315c can rotate in the substantially same direction of the air rotation within the primary cyclone by taking a central axis of the primary cyclone as a reference.

Even if the blades stop rotating, they can filter off the particles contained in the air. Yet, the rotating blades prevent the particles from escaping the blade filter with ease. Preferably, a rotational speed of the blade filter is appropriately preferably set according to a test result.

Optionally, an auxiliary filter can be provided to at least one of the inside and outside of the blade filter 315 to re-filter off particles contained in air. The auxiliary filter can have the same structure and shape of the blade filter 315. And, the auxiliary filter may include a filter of a porous member.

Meanwhile, a scatter-preventing member 317 is preferably provided under the blade filter 315 to prevent dust stored within the dust collecting container 330 from being scattered. The scatter-preventing member 317 plays a role in preventing the dust collected by the primary dust storing part from being introduced into the secondary cyclones 313.

For this, the scatter-preventing member 317 is preferably built in one body of a lower end of the blade filter 315. Preferably, the scatter-preventing member 317 has a radial shape so that an upper surface of the scatter-preventing member 317 is tilted downward toward its outer circumference. This facilitates the particles filtered off by the blade filter 315 to fall down to the dust collecting container.

Preferably, a scatter-preventing wing 317a is additionally provided under the scatter-preventing member 317 to assist the scatter-preventing member 317. The scatter-preventing wing 317a is extended under the scatter-preventing member 317 to play a role in preventing the dust collected by the dust collecting container from being scattered.

An upper cover 340 is detachably assembled to an upper part of the cyclone chamber 310.

A main filter assembly 341 is provided to the upper cover 340 to filter off particles from the air discharged from the secondary cyclones 313.

The main filter assembly 341 includes a main filter 341a of a porous member and a filter support member (not shown in the drawings) supporting the main filter 341a. And, the main filter assembly 341 is detachably assembled to tops of the secondary cyclones 313.

In particular, the main filter 341a is installed in a filter housing 341b communicating with the cyclone chamber 310. So, the air having passed through the main filter 341a is introduced into the cleaner body 100 via a third outlet 343 provided to the upper cover 340.

And, the cyclone chamber 310 may further include a cyclone cover 320 provided to an upper end of the cyclone chamber 310 to open or close the cyclone chamber 310.

A passage guide 321 is provided within the cyclone cover 320 to guide the air discharged from the first outlet 311b to the secondary cyclones 313 more smoothly.

And, a plurality of second outlets 331b are formed on an edge part of the cyclone cover 320 to discharge the air having passed through the secondary cyclones 313.

Meanwhile, the dust collecting container 330 is provided under the cyclone chamber 310 to store the dust separated by the cyclone chamber 310 therein.

The dust collecting chamber 330 includes a primary dust storing part 331 storing dust separated by the primary cyclone 311 and a secondary dust storing part 333 storing dist separated by the secondary cyclones 313.

A boundary wall is provided between the primary and secondary dust storing parts 331 and 333 to partition the primary and secondary dust storing parts 331 and 333 from each other. Namely, the boundary wall prevents the primary and secondary dust storing parts 331 and 333 from communicating with each other.

Preferably, the boundary wall is configured to have a curved shape in a circumferential direction. This is to prevent the dust stored in the primary dust storing part 331 from being scattered in a manner of eliminating a spiral flow formed by the primary cyclone 311.

A dust collecting container handle 335 is provided to a lateral side of the dust collecting container 330 to attach/detach the dist collecting container 330. And, a fixing device 500 is provided beneath the dust collecting container 330 to assemble/dissemble the dust collecting container 330 and the cyclone chamber 310.

The fixing device 500 will be explained later in the following description. Operations of the above-configured vacuum cleaner according to one embodiment of the present invention are explained with reference to FIGS. 3 to 6 as follows.

Referring to FIGS. 3 to 6, once the vacuum cleaner is driven, the air containing particles is introduced into the primary cyclone 311 via the intake nozzle 200 and the first connecting tube 410.

The air introduced via the first inlet 311a of the primary cyclone 311 is guided in a direction tangential to the inner wall of the primary cyclone 311.

In particular, the air introduced into the primary cyclone 311 forms a spiral flow along the inner wall of the primary cyclone 311 by the guide rib 312 provided to the first inlet 31a instead of being directly introduced into the blade filter 315.

So, relatively large and heavy dust separated by the cyclone principle falls to be stored in the primary dust storing part 331. In this case, the dust stored in the primary dust storing part 331 is prevented by the scatter-preventing member 317 from being scattered.

The air, from which the relatively large dust is separated, passes through gaps between the blades 315c of the blade filter 315 and is then discharged via the first outlet 311b provided to the ceiling of the primary cyclone 311.

In doing so, each of the blades 315c has a spiral flow of the air and a prescribed tilted angle, whereby particles contained in the discharged air can be re-filtered off.

Subsequently, the air having passed through the first outlet 3aab is introduced into a plurality of the secondary cyclones 313 to go through the dust separating process. The air, from which relatively small dust was separated by the secondary cyclones, is introduced into the upper cover 340 via the second outlet 331b.

The air introduced into the upper cover 340 is filtered by the main filter assembly 341 and is then discharged via the third outlet 343 provided to the upper end of the upper cover 340.

The air discharged from the third outlet 343 is sucked into the air intake device 150 provided to the cleaner body 100 via the second connecting tube.

Thereafter, the air having passed through the air intake device 150 moves along the third connecting tube and is then discharged outside via the exhaust chamber 600 provided to the lateral side of the cleaner body 100.

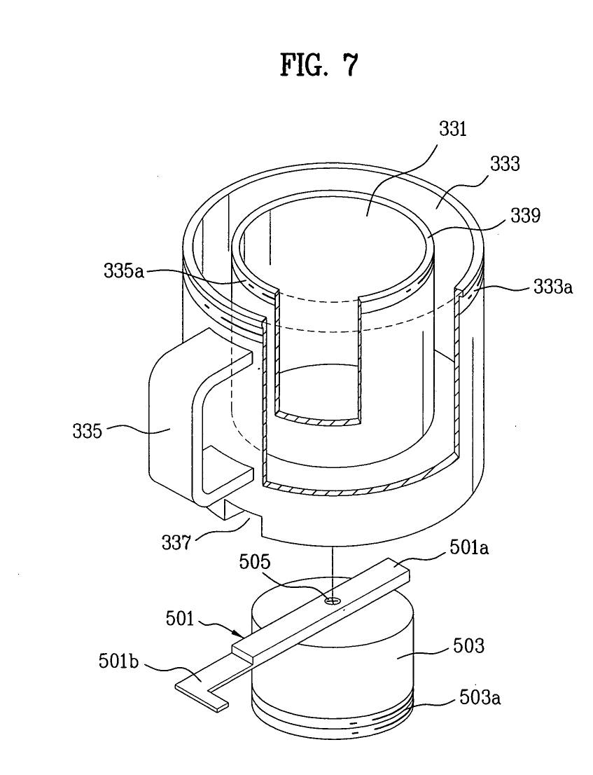

A fixing device according to one embodiment of the present invention is explained with reference to FIG. 7 as follows.

Referring to FIG. 7, a fixing device includes a lifting member 503 rotating to move upward or downward and a manipulating lever 501 manipulating a motion of the lifting member 503.

The manipulating lever 501 includes a manipulating lever handle 501b to move the lifting member 503 and a guide member 501a assembled to the lifting member 503.

The manipulating lever handle 501b is projected in a front direction of the cleaner body 100 and the guide member 501a is provided to a lower side of a bottom of the dust collecting container.

Alternatively, the guide member 501a is provided to a lower part of the lifting member 503 to move the lifting member 503 upward or downward. And, a shape of the manipulating lever handle 501b can be variously modified according to a design condition.

In this case, if a user turns to move the manipulating lever handle 501b in a circumferential direction, the guide member 501a built in one body of the manipulating lever handle 501b is turned as well. If so, the lifting member 503 assembled to the guide member 501a is rotated to move upward/downward.

Meanwhile, if the dust collecting container 330 is loaded in the cleaner body 100, the lifting member 503 is located under the dust collecting container 330. And, the lifting member 503 having a cylindrical shape is lifted upward/downward by the manipulating lever 501.

Alternatively, a shape of the lifting member 503 can be variously modified.

One end of the lifting member 503 is assembled to the cleaner body 100 by a screw, whereas the other end of the lifting member 503 is assembled to the manipulating lever 501 by a locking hole 505. In particular, a thread 503a is formed on an outer circumference of one side of the lifting member 503 to be assembled to the cleaner body 100, while a locking recess (not shown in the drawing) is formed on the other side to be assembled to the manipulating lever 501.

A guide recess 337 is formed on the bottom surface of the dust collecting container to correspond to the guide member 501a. If the manipulating lever 501 is turned, the guide member 501a provided to the manipulating lever 501 is turned together.

Simultaneously, the lifting member 503 assembled to the manipulating lever 501 is turned to move upward or downward. As the guide member 501a engages with the guide recess 337, the dust collecting container 330 is rotated by the turned guide member 501.

If so, a container thread formed on an upper rim of the dust collecting container 330 and a container thread 335a formed on an upper rim of the boundary wall 339 come into engaging with chamber threads (not shown in the drawing) formed on a lower end of the cyclone chamber, respectively. Alternatively, the thread can be formed on the upper rim of either the boundary wall or the container.

In particular, the container thread 335a plays a role as a male screw and the chamber thread plays a role as a female screw. As the dust collecting container 330 is rotated by the manipulating lever 501, the upper end of the dust collecting container 330 is selectively assembled to the lower end of the cyclone chamber 310.

Hence, airtightness is maximized in a manner of preventing the air from leaking between the upper end of the dust collecting container 330 and the lower end of the cyclone chamber 310.

Alternatively, the container thread 335a can play a role as a female screw and the chamber thread can play a role as a male screw.

Alternatively, the manipulating lever handle can rotate to move centering on a central axis of the manipulating lever. In particular, if the manipulating lever handle is turned counterclockwise, the lifting member is moved upward. If the manipulating lever handle is turned clockwise, the lifting member is moved downward.

For instance, a cam (not shown in the drawing) is installed at the cleaner body to switch a circular movement of the manipulating lever handle to a straight movement of the lifting member. In particular, the cam is assembled to the manipulating lever handle to enable its rotational movement and is provided under the lifting member.

Alternatively, a spur gear, which is assembled to a rotational shaft of the manipulating lever handle to rotate in the same rotational direction of the manipulating lever handle, is provided to the cleaner body. And, a gear part engaging with the spur gear is provided to the lifting member. So, the lifting member can move upward or downward.

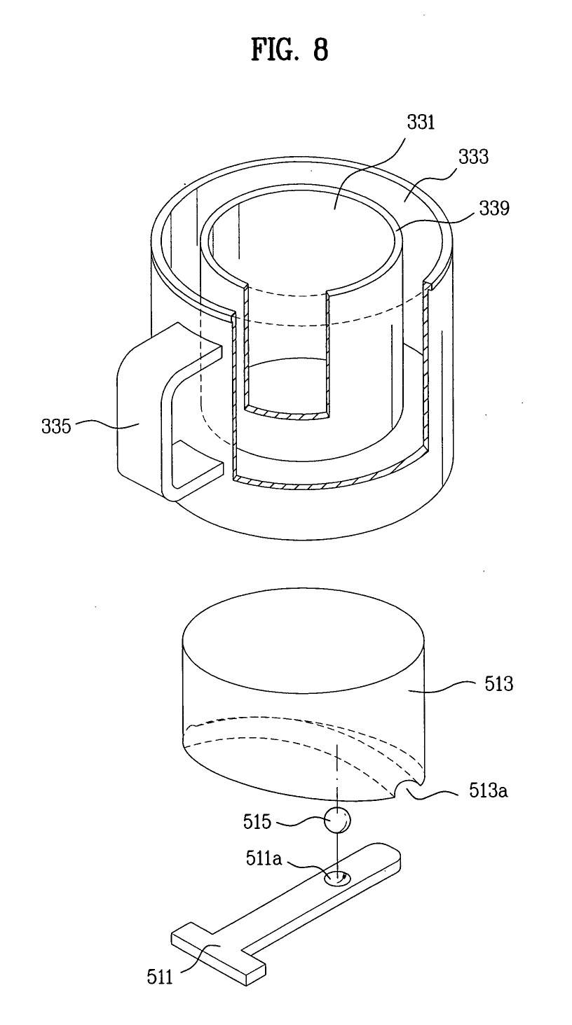

A fixing device according to another embodiment of the present invention is explained with reference to FIG. 8 as follows.

Referring to FIG. 8, a fixing device according to another embodiment of the present invention includes a lifting member lifted by a relative movement to a manipulating lever. And, the lifting member of the fixing device is configured to be lifted by a rotational manipulation of the manipulating lever.

Unlike the fixing device according to the former embodiment of the present invention, the fixing device according to another embodiment of the present invention includes a lifting member 513 moving upward/downward without being rotated, a manipulating lever 511 manipulating a movement of the lifting member 513, and a connecting member provided between the lifting member 513 and the manipulating lever 511.

The connecting member makes a rotational or straight movement between the lifting member 513 and the manipulating lever 511 to play a role in converting a rotational movement of the manipulating lever 511 to an upward/downward movement of the lifting member 513. In the present embodiment, a ball moving on a bottom surface of the lifting member 513 together with a rotation of the manipulating lever 511 is used as the connecting member. In particular, the ball 515 is installed at a ball holder 511a provided to the manipulating lever 511.

An upper surface of the lifting member 513 contacting with the dust collecting container 330 is parallel to a bottom surface of the dust collecting container 330 and a lower surface of the lifting member 513 contacting with the manipulating lever 511 is tilted at a prescribed angle. In particular, the lifting member 513 has a cylindrical shape cut slant from its upper part to its lower part.

A groove 513a is provided to a lower surface of the lifting member 513 to enable the ball 515 to move. In particular, the groove 513a is configured to have a prescribed curvature corresponding to a moving trajectory of the ball 515.

An operational process of the above-configured fixing device is explained in brief as follows.

First of all, to fix the dust collecting chamber 330 to a lower part of the cyclone chamber, the dust collecting container 330 is placed on an upper surface of the lifting member 513. The manipulating lever 511 is then turned counterclockwise.

In doing so, the ball 515 inserted in the ball holder 511a comes into moving along the groove 513a formed on the lower surface of the lifting member 513.

Although the manipulating lever 511 supported by the cleaner body is turned in a horizontal direction, since the lower surface of the lifting member 513 contacting with the ball 515 has a prescribed tilted angle, the lifting member 513 starts ascending as soon as the ball moves.

In particular, if the ball 515 moves to a lower position of the lower surface of the lifting member 513 along the groove 513a, the lifting member 513 moves in an upper direction. The dust collecting container put on the upper surface of the lifting member 513 is moved in the upper direction by the moving lifting member 513.

The dust collecting container moved upward by the manipulation of the manipulating lever 511 adheres closely to the lower end of the cyclone chamber 310 provided to the cleaner body to be fixed thereto.

In particular, a locking recess having a prescribed shape provided to a lower rim of the cyclone chamber comes into engaging with a locking projection provided to an upper time of the dust collecting container.

Alternatively, a flange is provided to the upper rim of the dust collecting container to be fitted in the locking recess.

Meanwhile, in case of separating the dust collecting container from the cyclone chamber, the manipulating lever is just turned in a reverse direction only, which is not explained in the following description.

Hence, if a user turns the manipulating lever in the horizontal direction, the lifting member and the dust collecting container are moved upward/downward so that the dust collecting container can be assembled/dissembled to/from the cyclone chamber 310.

Optionally, a sealing member can be provided between the cyclone chamber 310 and the dust collecting container 330 to enhance airtightness between the dust collecting container 330 and the cyclone chamber 310.

Alternatively, a guide projection having a prescribed tilted angle can be used as the connecting member. The guide projection is provided under the lifting member. In this case, the lifting member and the guide projection are installed to have a prescribed tilted angle in-between.

In other words, a contact boundary between the lifting member and the guide projection is formed tilted. In particular, by taking the contact boundary as a reference, the guide projection has a cylindrical shape cut slant from its lower part to its upper part and the lifting member has a cylindrical shape cut slant from its upper part to its lower part.

If the manipulating lever built in one body of the guide projection is turned, a tilted surface of the guide projection moves along a tilted surface of the lifting member. If so, the lifting member fixed to a rotational direction of the manipulating lever comes into moving in a vertical direction only.

Alternatively, a lifting guide can be provided to the cleaner body to protect the lifting member and to guide a vertical direction. Alternatively, the lifting member can be projected to have a prescribed height before the dust collecting container is installed. And, a recess corresponding to a projected height of the lifting member can be provided to a bottom of the dust collecting container.

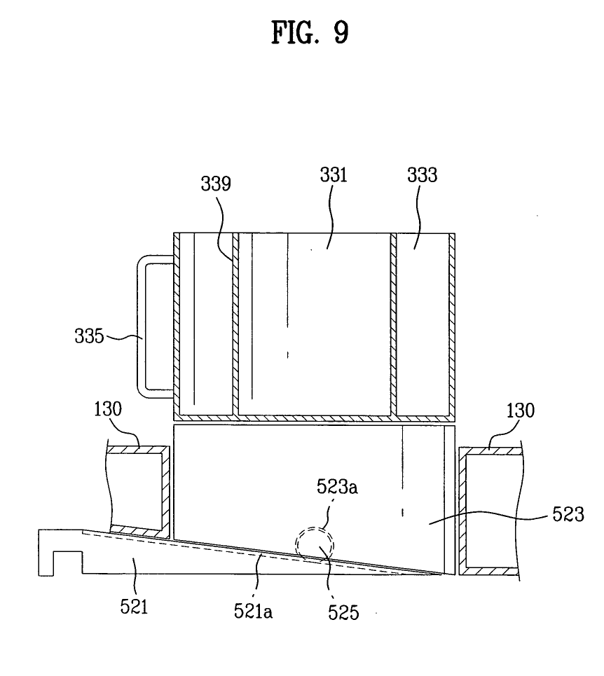

A fixing device according to a further embodiment of the present invention is explained with reference to FIG. 9 as follows.

Referring to FIG. 9, a fixing device according to a further embodiment of the present invention includes a lifting member lifted by a relative movement to a manipulating lever. And, the lifting member of the fixing device is configured to be lifted by a straight movement of the manipulating lever.

Unlike the fixing device according to the former embodiments of the present invention, the fixing device according to a further embodiment of the present invention includes a manipulating member 521 enabling front and rear movements, a lifting member 523 moving upward/downward according to the movement of the manipulating lever 521, and a ball 525 provided between the lifting member 523 and the manipulating lever 521.

The manipulating lever 521 is provided under the lifting member 523. An upper surface of the manipulating lever 521 has a prescribed tilted angle in a front-to-rear direction. And, a groove 521a is provided to an upper surface of the manipulating lever 521 to enable the ball 525 to move.

A lower surface of the lifting member 523 contacts with the manipulating lever 521 and an upper surface of the lifting member 523 directly contacts with the dust collecting container.

A ball holder 523a is provided to the lower surface of the lifting member to have the ball 525 inserted therein. And, the lower surface of the lifting member has a tilted angle to correspond to the upper surface of the manipulating lever 521. Moreover, a Lifting guide is provided to each side of the lifting member 523 to be supported by the cleaner body.

Alternatively, the ball may not be separately provided between the lifting member and the manipulating lever. In particular, the lifting member and the manipulating lever can be directly moved with prescribed friction in-between.

An operational process of the above-configured fixing device is explained in brief as follows.

First of all, after the manipulating lever has been pulled in a front direction of the cleaner body, the dust collecting container is placed over the lifting member. The manipulating lever is then pushed in a direction of the cleaner body.

If so, the lifting lever is moved in an upper direction according to the tilted angle of the manipulating lever. So, the lifting member lifts up the dust collecting container so that the dust collecting container can be assembled to the cyclone chamber 310. Optionally, a sealing member is provided between the cyclone chamber 310 and the dust collecting container 330 to enhance airtightness between the dust collecting container 330 and the cyclone chamber 310.

Meanwhile, the above-configured dust collecting device according to the present invention is applicable to a canister or upright type vacuum cleaner to use.

Accordingly, the present invention provides the following effects or advantages.

First of all, by providing the fixing device enabling the dust collecting container to be separated from the cleaner body, a user can easily empty the dust collecting container. And, the dust collecting device is facilitated to use, whereby reliability of a product can be enhanced.

Secondly, the threads are provided to both of the dust collecting device and the cyclone chamber to enable a screw locking, whereby dust collecting performance of the dust collecting device can be raised. By providing the sealing member between the dust collecting container and the cyclone chamber, airtightness of the dust collecting device can be enhanced.

Thirdly, the guide member is provided to the manipulating lever and the guide groove or recess is provided to the dust collecting container to correspond to the guide member. Hence, the dust collecting container is facilitated to be assembled to the cleaner body. Since the guide recess and the guide member are rotated by engaging with each other, a force of the lifting member can be easily transferred to the dust collecting container.

Fourthly, in separating the dust collecting container from the cleaner body, the dust collecting container can be detached from the cleaner body without being tilted, whereby the particles collected within the dust collecting container can be prevented from being discharged outside.

Fifthly, by providing the cam engaging with the manipulating lever to the cleaner body, the rotational movement of the manipulating lever is facilitated to be converted to the straight movement of the lifting member.

By providing the spur gear coupled with the manipulating lever to the cleaner body and by providing the gear part engaging with the spur gear to one side of the lifting member, the lifting member is facilitated to be controlled.

Sixthly, by providing the connecting member such as the ball and the guide member between the lifting member having the bottom surface tilted at a prescribed angle and the manipulating lever, the rotational movement of the manipulating lever is facilitated to be converted to the vertical movement of the lifting member.

Seventhly, by moving the manipulating lever tilted at the prescribed angle in a front-to-rear direction, the movement of the lifting member can be easily controlled.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A vacuum cleaner comprising:
a cleaner body;
a cyclone chamber, comprising:
a primary cyclone separating particles from an introduced air; and
at least one secondary cyclone provided outside the primary cyclone to re-separate particles contained in the air discharged from the primary cyclone;
a dust collecting container detachably assembled to the cleaner body, the dust collecting container comprising:
a primary dust storing part storing dust separated by the primary cyclone; and
a secondary dust storing part storing dust separated by the at least one secondary cyclone; and
a fixing means for assembling/dissembling the dust collecting container and the cyclone chamber.

2. The vacuum cleaner of claim 1, further comprising a main filter assembly having a main filter filtering off the particles from the air discharged from the at least one secondary cyclone and a filter support member supporting the main filter.

3. The vacuum cleaner of claim 2, wherein the main filter assembly is detachably provided to an upper part of the at least one secondary cyclone.

4. The vacuum cleaner of claim 1, the fixing means comprising:
a lifting member provided to the cleaner body to be lifted in a vertical direction; and
a manipulating member manipulating a movement of the lifting member.

5. The vacuum cleaner of claim 4, wherein the lifting member is lifted by a rotational manipulation of ht e manipulating lever.

6. The vacuum cleaner of claim 5, wherein the lifting member is locked to the cleaner body by a screw to be rotatably lifted by the rotational manipulation of the manipulating lever.

7. The vacuum cleaner of claim 5, wherein the dust collecting container is rotated together with the manipulating lever to be lifted by the lifting member.

8. The vacuum cleaner of claim 1, wherein the manipulating lever includes a guide member coupled with an upper side of the lifting member, wherein a guide recess corresponding to the guide member of the manipulating lever is formed on a bottom of the dust collecting container, and wherein the guide member and the guide recess engage with each other in loading the dust collecting container in the cleaner body.

9. The vacuum cleaner of claim 7, wherein a male screw and a female screw are provided to the dust collecting container and the cyclone chamber, respectively, and vice versa and wherein the dust collecting container and the cyclone chamber are screw-locked together if the dust collecting container is rotated by the manipulating lever.

10. The vacuum cleaner of claim 4, wherein the lifting member is lifted by a relative movement to the manipulating lever.

11. The vacuum cleaner of claim 10, wherein the lifting member is lifted by a rotational manipulation of the manipulating lever.

12. The vacuum cleaner of claim 11, the fixing means further comprising a ball provided between the lifting member and the manipulating lever to make a rolling movement between the lifting member and the manipulating lever by a rotation of the manipulating lever.

13. The vacuum cleaner of claim 12, wherein the manipulating lever is provided under the lifting member and wherein a groove corresponding to a trajectory of the ball is formed on a lower surface of the lifting member.

14. The vacuum cleaner of claim 13, wherein the lower surface of the lifting member has a tilted shape.

15. The vacuum cleaner of claim 10, wherein the lifting member is lifted by a straight movement of the manipulating lever.

16. The vacuum cleaner of claim 15, wherein the lifting member is lifted in the vertical direction by a front-to-rear movement of the manipulating lever.

17. The vacuum cleaner of claim 16, the fixing means further comprising a ball provided between the lifting member and the manipulating lever to make a rolling movement between the lifting member and the manipulating lever by the straight movement of the manipulating lever.

18. The vacuum cleaner of claim 17, wherein the manipulating lever is provided under the lifting member and wherein a groove corresponding to a trajectory of the ball is formed in a front-to-rear direction on a lower surface of the lifting member.
